(19) United States
(12) Patent Application Publication
(10) Pub. No.: US 2008/0257580 A1
(43) Pub. Date: Oct. 23, 2008

(54) Cable harness

(76) Inventor: Takeki Ishimoto, Tochigi (JP)

Correspondence Address: MCDERMOTT WILL & EMERY LLP, 600 13TH STREET, N.W., WASHINGTON, DC, 20005-3096, US

(21) Appl. No.: 12/081,106

(22) Filed: Apr. 10, 2008

(30) Foreign Application Priority Data
Apr. 10, 2007 (JP) P.2007-102636

(51) Int. Cl. H02G 3/04

(52) U.S. Cl. 174/68.1

(57) ABSTRACT

A cable harness is provided with electric wires arranged in rows to maintain intervals therebetween at both terminals thereof. An intermediate portion of the cable harness is divided into at least two electric wire groups and bundled. At least one of the wire bundles has a length different from those of another electric wire bundles.

### BACKGROUND OF INVENTION

1. Field of the Invention

The present invention relates to a multiconductor cable harness which includes electric connectors connected to both ends of a plurality of electric wires and is bundled at the intermediate portion.

2. Description of the Related Art

Mobile phones and small-sized video cameras have become widespread, and further reductions in size and weight of these small-sized mobile devices have been demanded. These small-sized devices have a device main body and a display unit consisting of a liquid crystal display. When the device is not used, the device is folded compactly by applying relative movements such as rotation, twisting, or sliding, etc., to the device main body and the display unit for convenient storage. The device main body and the display unit are electrically connected via a plurality of electric wires (coaxial cables). The electric wires are reduced in diameter according to downsizing of the device, and a cable harness for preventing disconnection at a movable portion where rotation, twisting, etc., is applied has been demanded.

With such a cable harness, for example, as disclosed in JP-A-2005-235690, both ends of the cable are arranged in a row at predetermined intervals and connected to electric connectors, and the intermediate portion is bundled so as to easily rotate or twist. In this case, by appropriately setting the lengths of the electric wires connected to the electric connector along the width direction of the electric connector, disconnection hardly occurs.

FIG. 3 shows an example in which electric connectors 13 and 14 are connected to the ends of a cable harness 11 having a plurality of electric wires (insulated wires) or coaxial cables 12. The intermediate portion 15 of a cable is bundled with tape to form the cable harness 11. In this cable harness, when the cable length is long, the plurality of electric wires or coaxial cables 12 may be all equal in length, but may be different from each other. However, when the cable harness bundled at the intermediate portion 15 is used at a movable portion, the bending diameters at the inner side and the outer side of the cable bundle are different from each other, so that a stress occurs and possibility of a disconnection increases.

Particularly, as the movable range of the device is extended, the cable harness bending and twisting angles also increase. On the other hand, according to an increase in the information amount to be transmitted, the number of conductors of the cable harness increases, and the wire bundle of the cable becomes thicker. When bending or twisting is applied thereto, the difference between the bending diameters at the inner side and the outer side of the wire bundle increases. In this case, the wire bundle may fully stretch and cannot bend. If it is forcibly bent, disconnection frequency increases.

### SUMMARY OF INVENTION

One or more embodiments of the invention provide a cable harness having electric connectors connected to both ends thereof and bundled at an intermediate portion, which can be used at a movable portion whose movable range is wide, and does not cause disconnection.

According to a first aspect of the invention, a cable harness is provided with electric wires arranged in rows to maintain intervals therebetween at both terminals thereof, wherein an intermediate portion of the cable harness is divided into at least two electric wire groups and each group is bundled to form a wire bundle, and at least one of the wire bundles has a length different from those of another electric wire bundles.

According to a second aspect of the invention, the wire bundles are separated from each other up to the terminal portions, and the electric wires are individually arranged to maintain intervals at the respective terminal portions.

According to a third aspect of the invention, the cable harness is capable of being bent when the cable harness is used at a movable portion of a device.

According to a forth aspect of the invention, the cable harness is provided with electric connectors connected to one of the ends of the respective wire bundles.

According to the cable harness of the one or more embodiments of the present invention, even when it is used at a movable portion which rotates, twists, or slides, etc., the stress due to the difference between bending diameters of the inside and the outside of the wire bundle of the cable can be reduced. As a result, the bending or twisting movable range of the cable increases, disconnections are reduced, and the device reliability can be improved.

Other aspects and advantages of the invention will be apparent from the following description and the appended claims.

### BRIEF DESCRIPTION OF THE DRAWINGS

FIG. 1 is a view showing an embodiment of the present invention,

FIG. 2 is a view showing another embodiment of the present invention, and

FIG. 3 is a view showing a conventional art.

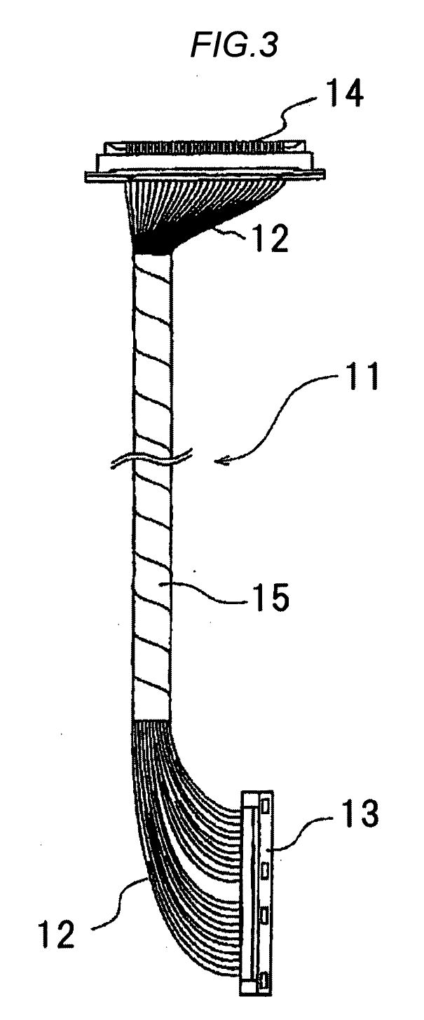

### DESCRIPTION OF EXEMPLARY EMBODIMENTS

The present invention relates to a cable harness in which both terminal portions of a plurality of electric wires are arranged in a row so that predetermined intervals between the electric wires are maintained. The invention includes, for example, the case where electric connectors are connected to the terminals, and the case where no electric connectors are connected to the terminals but the electric wires are bonded with a ground bar or resin tape so as to maintain the predetermined intervals. The cable harness having terminals to which electric connectors are connected is electrically connected to a circuit provided on a board, etc., via the electric connectors. A cable harness having terminals to which no electric connectors are connected is directly electrically connected to a circuit provided on a board or FPC (flexible printed circuit).

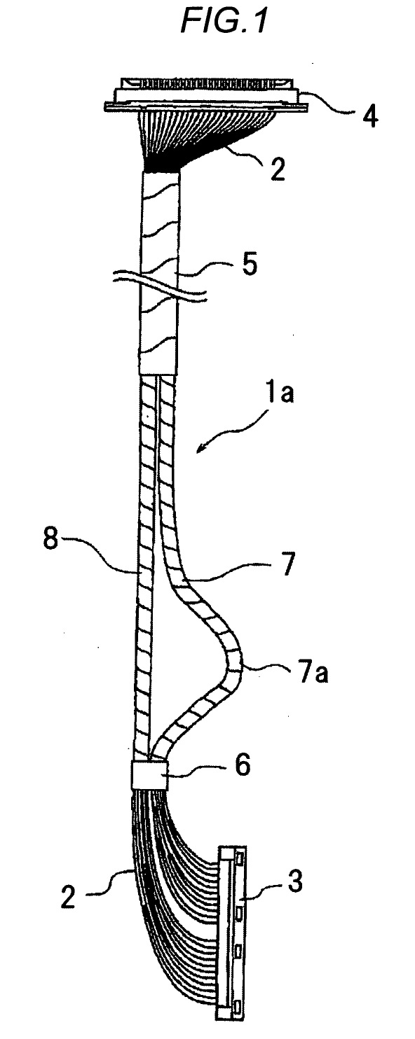

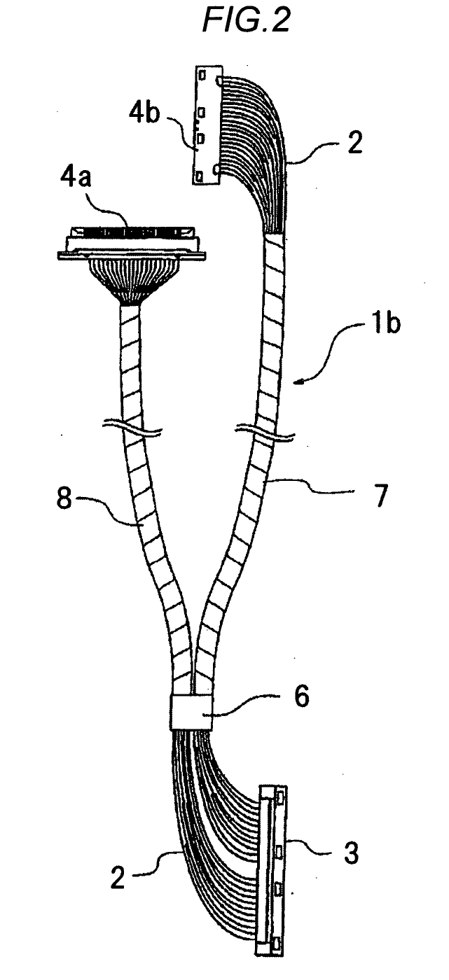

Embodiments of the present invention will be described with reference to the drawings. FIG. 1 shows a construction example including electric connectors one for each of the ends of a cable, and FIG. 2 shows a construction example including one electric connector on one of the ends of the cable and two electric connectors on the other end. In the figures, reference numerals 1a and 1b denote a cable harness, 2 denotes electric wires (coaxial cables), 3, 4, 4a, and 4b denote an electric connector, 5 denotes a collective wire bundle, 6 denotes a unifying portion, 7 and 8 denote a wire bundle, and 7a denotes an extra length portion.

In the cable harness la shown in FIG. 1, for example, both ends of a plurality of electric wires 2 are arranged in a row at predetermined intervals, electric connectors 3 and 4 are connected thereto, and an intermediate portion is bundled with tape or the like to form a wire bundle. The electric wires 2 are, for example, extra fine insulated wires or coaxial cables with an outer diameter not more than 0.5 millimeters. The insulated wires and coaxial cables may be mixed and used.

In one cable harness, the number of electric wires 2 is, for example, 32 to 40 in many cases, however, in the present invention, the number may be less or more. Then, at the intermediate portion of the cable to be bundled with tape or the like, the plurality of electric wires are divided into two electric wire groups, and wire bundles 7 and 8 are formed by winding tape around each electric wire group. The numbers of divided electric wires are not necessarily equal to each other, however, desirably, at least not less than 10.

The two wire bundles 7 and 8 are made different in wire length from each other. As to which of the wire bundles is to be made longer, this depends on the arrangement of the cable harness, and as to how much the wire length difference is, this depends on the cable bending diameter at the movable portion. Electric connectors 3 and 4 are collectively connected one each to each of the ends of the wire bundles 7 and 8.

In FIG. 1, one electric connector 3 is connected in an L shape so that its connection terminal row is parallel to the longitudinal direction of the cable, and the electric connector 4 on the opposite side is connected in a T shape so that the connection terminal row is orthogonal to the longitudinal direction of the cable. These shapes and connecting forms of the electric connectors change depending on a wiring form in a device and a connector shape. It is illustrated that a space remains between the wire group included in the wire bundle 7 and the wire group included in the wire bundle 8, and these groups are connected to the electric connector 3 separately. In FIG. 1, an example in which both groups are arranged side by side and connected is shown, however, they may be arranged in a two-tiered manner.

The start ends and terminal ends of the two-divided wire bundles 7 and 8 can be unified by the unifying portion 6 into one bundle. Portions other than the one-unified bundle portion of the wire bundles 7 and 8 at the unifying portion 6 may be formed into wire bundles independent from each other. However, they may be partially two-branched and remaining portions are bundled as a collective wire bundle 5. In this case, the longer wire bundle of the wire bundles 7 and 8 is partially independent and sagged as an extra length portion 7a.

In the cable harness 1b of the example shown in FIG. 2, similar to the example of FIG. 1, both ends of the plurality of electric wires 2 are arranged in a row at predetermined intervals, electric connectors 3 and 4a and 4b are connected thereto, and the intermediate portions are bundled with tape, etc. As the electric wires 2, insulated wires or coaxial cables with an outer diameter not more than 0.5 millimeters are used. The insulated wires and coaxial cables may be mixed and used.

The plurality of electric wires 2 are bundled as one electric wire bundle and arranged normally. However, these electric wires are divided into, for example, two electric wire groups, and one wire group is made longer than the other wire group, and the electric connector 4a or 4b is connected in an L shape or a T shape to one of the ends of these wire groups. Two electric connectors 4a and 4b are used dividedly instead of one electric connector.

To the other ends of the two-divided wire groups, for example, one electric connector 3 is connected in an L shape or a T shape. Accordingly, the two-divided wire groups are in a branched shape including two electric connectors 4a and 4b and one electric connector 3. Tape may be individually wound around the intermediate portions between the connectors to form divided wire groups 7 and 8. These wire groups 7 and 8 may be wired together at a movable portion in a device in a bendable manner.

The start portions of the wire bundles on the side to be connected to the electric connector 3 can be unified as a unifying portion 6 similar to the example of FIG. 1. The terminal ends of the wire bundles on the opposite side of the unifying portion 6 remain two-divided, and the electric connectors 4a and 4b connected to the respective wire bundles 7 and 8 are connectable independently. In FIG. 2, the electric connectors 4a and 4b different in shapes (L shape and T shape) from each other are illustrated, however, they may be completely the same in shape.

In the embodiments shown in FIG. 1 and FIG. 2, examples in which the number of divided electric wire bundles is two are shown. However, the electric wires may be divided into three or more wire bundles. In this case, at least one of the plurality of wire bundles is formed so as to be different in length from other wire bundles. However, more preferably, the lengths of the wire bundles are all different from each other.

Examples in which bundling tape is continuously wound around the wire bundles 7 and 8 are shown, however, a thread or string may be used instead of the tape, and intermittent partial bundling is also allowed as well as continuous winding and bundling with tape, etc.

With the cable harness constructed as described above, the diameter of each divided wire bundle can be made smaller than in the construction of the conventional single wire bundle at the intermediate portion. When the cables are bent, the difference between the bending outer diameter and the bending inner diameter can be reduced. Thus, bending becomes easy and the stress can be reduced. In addition, by making the wire bundle positioned at the bending outer side longer than the wire bundle positioned at the bending inner side, the stress on the cable can be dispersed to the inner side wire bundle and the outer side wire bundle and reduced in comparison with the construction of the conventional single wire bundle.

When the cable harness described above is used for electric wiring on a movable portion that rotates, twists, or slides such as a portion between a device main body and a liquid crystal display unit, bending of the cable at the movable portion is easy, and the stress on the cable at the bending portion is reduced and disconnections are reduced, and the device reliability can be improved.

The example in which electric connectors are attached to the terminals is described above, however, the same effect can be obtained even when electric wires are fixed by soldering to a ground bar or the electric wires are bonded with resin tape to maintain the predetermined intervals between the respective electric wires without attaching electric connectors to the terminals, and even when the intermediate portion is branched into two or more wire bundles.

What is claimed is:

1. A cable harness comprising:
electric wires arranged in rows to maintain intervals therebetween at both terminals thereof,
wherein an intermediate portion of the cable harness is divided into at least two electric wire groups and each group is bundled to form a wire bundle, and
at least one of the wire bundles has a length different from those of another electric wire bundles.

2. The cable harness according to claim 1,
wherein the wire bundles are separated from each other up to the terminal portions, and the electric wires are individually arranged to maintain intervals at the respective terminal portions.

3. The cable harness according to claim 1, wherein the cable harness is capable of being bent when the cable harness is used at a movable portion of a device.

4. The cable harness according to claim 2, further comprising electric connectors connected to one of the ends of the respective wire bundles.
